(19) United States
(12) Patent Application Publication
(10) Pub. No.: US 2026/0131378 A1
(43) Pub. Date: May 14, 2026

(54) METHOD AND SYSTEM FOR FABRICATION OF MULTI-MATERIAL COMPONENTS

(71) Applicant: Saeed MALEKSAEEDI, Waterloo (CA)

(72) Inventor: Saeed MALEKSAEEDI, Waterloo (CA)

(21) Appl. No.: 19/118,017

(22) PCT Filed: Oct. 11, 2023
(86) PCT No.: PCT/CA2023/051340

§ 371 Date: Apr. 3, 2025

Related U.S. Application Data
(60) Provisional application No. 63/414,990, filed on Oct. 11, 2022.

(51) Int. Cl. B22F 7/06; B22F 3/26; B22F 10/60; B22F 10/64; B33Y 10/00; B33Y 40/20; B33Y 80/00

(52) U.S. Cl. CPC B22F 7/06; B22F 3/26; B22F 10/60; B22F 10/64; B33Y 10/00; B33Y 40/20; B33Y 80/00

(57) ABSTRACT

The disclosure is directed at multi-material components and a method and system for fabricating same. The multi-material component includes a pre-form that includes the combination of a gap filler material and an infiltrant which are inserted into the pre-form during the fabrication process.

### CROSS-REFERENCE TO OTHER APPLICATIONS

The disclosure claims priority from U.S. Provisional Application No. 63/414,990 filed Oct. 11, 2022 which is hereby incorporated by reference.

### FIELD

The disclosure is generally directed at the field of manufacturing and, more specifically, at multi-material components and method and systems for fabrication multi-material components.

### BACKGROUND

Fabrication routes for multi-material components play a pivotal role in modern engineering and manufacturing due to their impact on the physical and mechanical properties of parts, as well as the ability to introduce entirely new functionalities. By seamlessly integrating different materials into a single component, these methods empower engineers to tailor materials to specific requirements, enhancing properties such as strength, durability, crack tolerance and thermal performance. Furthermore, multi-material fabrication opens doors to novel functionalities, enabling the creation of intelligent, multifunctional components that can perform tasks beyond traditional materials' capabilities. In a world where innovation and efficiency are paramount, the development of methods and systems for fabricating multi-material components holds importance in advancing technology and addressing complex engineering challenges.

Additive manufacturing (AM) facilitates multi-material fabrication by enabling precise layer-by-layer deposition of materials, creating complex structures, and allowing the integration of different materials within a single component. This technology reduces waste, supports rapid prototyping, and enables functional integration, making it a valuable tool for industries seeking enhanced performance and customized solutions.

Tooling has emerged as one of the most successful applications of additive manufacturing (AM), thanks to its ability to revolutionize traditional manufacturing processes. In tooling applications, AM allows for the creation of complex, customized molds and dies with features like conformal cooling channels. Additionally, AM significantly shortens lead times for tool production, eliminating the need for costly and time-consuming tooling setups. As a result, industries such as automotive and aerospace are benefiting from reduced production costs, faster development cycles, and improved overall manufacturing performance, all made possible by the innovative capabilities of additive manufacturing in the realm of tooling.

The typical practice in tooling industry such as the one in die casting, focuses on producing of inserts, rather than the entire die or mold. However, these inserts can sometimes be bulky and demand substantial amounts of material and AM processing time.

Therefore, there is provided a novel method and system for fabrication of multi-material components.

### SUMMARY

The disclosure is directed at a multi-material component or item and methods and systems for fabricating the multi-material component. In one embodiment, the disclosure includes a hollow component portion that is made with various lattice structures using additive manufacturing (AM) technology whereby the empty space within the lattice structures is filled with a secondary powder. The secondary powder may be seen as a “gap filler material” possessing pre-determined thermal or physical properties. An infiltration process the follows the filling of the remaining hollow or empty spaces. The surface of the gap filler material may be metallized for better adhesion to infiltrant metal.

In one embodiment, the infiltration process may be combined with a heat treatment cycle. A heat treatment cycle is a known post treatment for many AM parts. The thermal stresses due to solidification shrinkage of infiltrant is compensated with low thermal expansion characteristics of the gap filler to match that of the base metal. By controlling the parameters of lattice structure, composition of the infiltrant and gap filler, a very good site-specific control over various properties of material including thermal, mechanical, magnetic or electrical properties can be experienced or enabled.

In one aspect of the disclosure, there is provided a method of fabricating a multi-material component made of a base metal including fabricating a pre-form with at least one hollow region; adding at least one gap filler material to the pre-form; and performing an infiltration process to fill a remainder of the at least one hollow region with at least one infiltrant material.

In another aspect, the method includes decorating the at least one gap filler material before or after adding the at least one gap filler material to the pre-form. In a further aspect, fabricating a pre-form includes fabricating a shell portion for housing the at least one gap filler material and the at least one infiltrant material. In yet another aspect, fabricating a pre-form further includes fabricating an internal structure within the shell portion. In yet a further aspect, the internal structure is a lattice structure. In another aspect, the lattice structure is a triply periodic minimal surface (TPMS) structure.

In another aspect, fabricating a pre-form includes fabricating an internal structure; and inserting the internal structure within a mold. In yet a further aspect, the method includes finishing the pre-form to fabricate a finished multi-material component. In another aspect, the method includes integrating the finished multi-material component with other components of a larger finished item. In an aspect, the method includes performing a heat treatment on the pre-form after performing the infiltration process.

In another aspect of the disclosure, there is provided a multi-material component including at least one gap filler material; and at least one infiltrant material mixed with the at least one gap filler material.

In another aspect, the component further includes a lattice structure. In yet another aspect, the component further includes shell portion. In another aspect, the shell portion is of varying thickness.

In a further aspect, the at least gap filler material is selected from tungsten, molybdenum, tungsten carbide, high strength steels, silicon carbide, tantalum carbide, titanium carbide, graphite or diamond, boron carbide, boron nitride, silicon nitride aluminum nitride or aluminum oxide. In yet a further aspect, the at least one infiltrant material is selected from a silver copper alloy, a silver alloy, a copper alloy, bronze, nickel aluminide, iron aluminide, silicon, aluminium, a cobalt alloy, palladium, indium, tin, titanium or gold. In yet another aspect, the component further includes at least one decorating material. In yet another aspect, the at least one decorating material is selected from silver nanoparticles, gold nanoparticles, nickel coating or a silver coating.

### DESCRIPTION OF THE DRAWINGS

Some embodiments of the present invention are illustrated as an example and are not limited by the figures of the accompanying drawings, in which like references may indicate similar elements and in which:

FIG. 1a is a perspective view of a multi-material component;

FIG. 1b a perspective cut-away view of an empty shell portion of the multi-material component of FIG. 1a;

FIG. 1c is a perspective cut-away view of the multi-material component of FIG. 1a showing the shell portion and a lattice structure;

FIG. 1d is a perspective cut-away view of the multi-material component of FIG. 1a showing a filled shell portion and the lattice structure;

FIG. 1e is a cut-away front view of the multi-material component;

FIGS. 1f to 1h are perspective cut-away views of embodiments of a multi-material component;

FIGS. 1i to 1k are perspective cut-away views of a further embodiment of a multi-material component;

FIGS. 2a to 2d are examples of lattice structures;

FIG. 3a is a flowchart showing a method of fabricating a multi-material component;

FIG. 3b is a schematic diagram of another method of fabricating a multi-material component;

FIG. 3c is a schematic diagram of an infiltration process setup;

FIG. 3d is a schematic diagram of another method of fabricating a multi-material component;

FIG. 3e is a set of schematic drawings showing a pre-form before and after undergoing an infiltration process;

FIG. 3f is a set of schematic diagrams showing results of a lattice structure after receiving a single infiltrant/gap filler combination and after receiving a dual infiltrant/gap filler combination;

FIG. 3g is a set of drawings showing infiltration of tungsten with silver alloy; and

FIG. 4 is a chart showing time savings using one method of the disclosure.

### DESCRIPTION

The disclosure is directed at a multi-material component and methods and systems for fabrication of the multi-material component. In some embodiments, the fabrication may be performed via additive manufacturing (AM), however, the method of fabrication of the disclosure may also be used in conventional manufacturing settings. In some embodiments, the multi-material component may be seen as a final product and, in other embodiments, the multi-material component may be combined with other multi-material or non-multi-material components to form a larger item (or final product).

In one embodiment, the disclosure is directed at a method for fabrication of a multi-material component to enhance certain properties of or to add new functions to the multi-material component that is an improvement over components fabricated via current single-material AM processes. In another embodiment, the disclosure includes the fabrication of a pre-form with hollow spaces at the surface or inside of the pre-form that is subsequently filled with other materials or powders. The other materials may be seen as secondary materials.

In one embodiment, there is provided a method of fabricating a multi-material component made of a base metal that includes manufacturing the component with a hollow portion; fabricating at least one lattice structure within the hollow portion; filling the at least one lattice structure with a gap filler powder; and combining an infiltration process in add an infiltrant with a heat treatment cycle process.

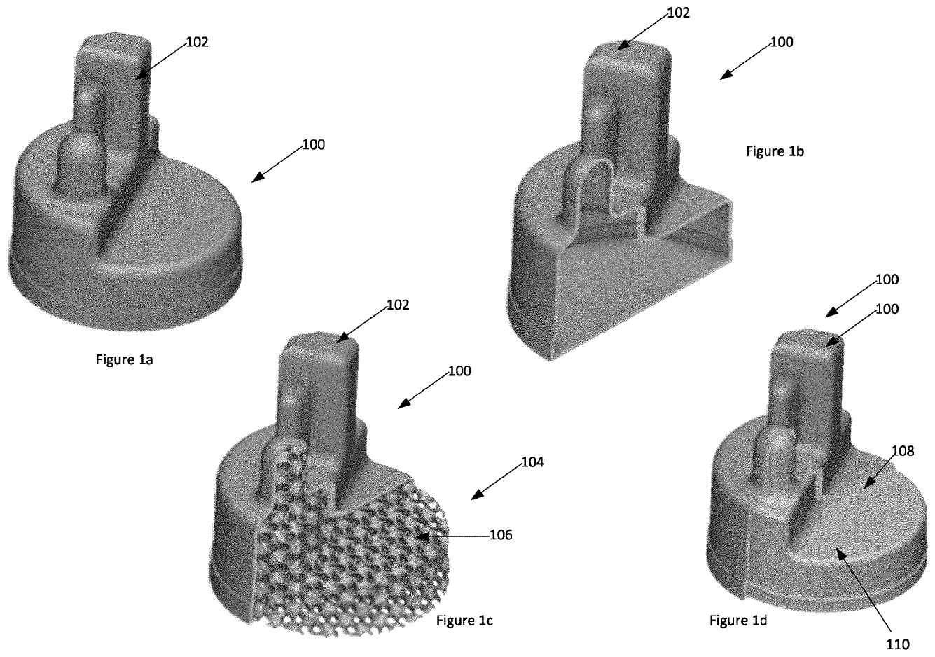

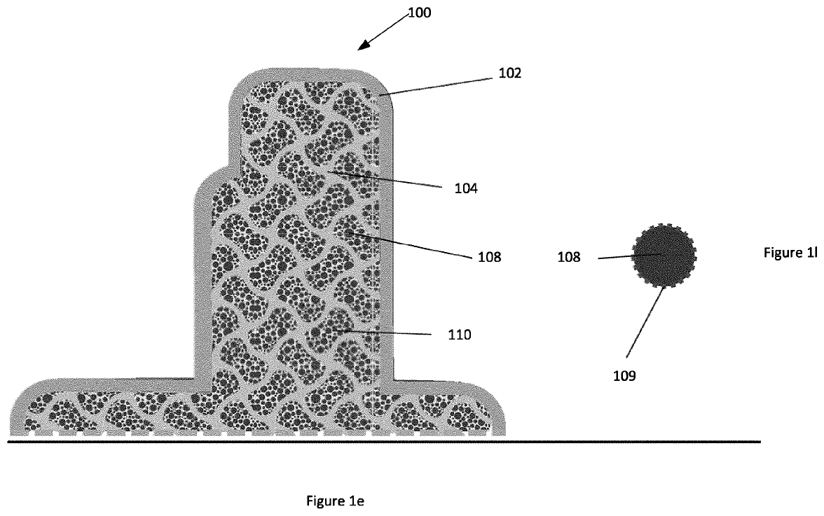

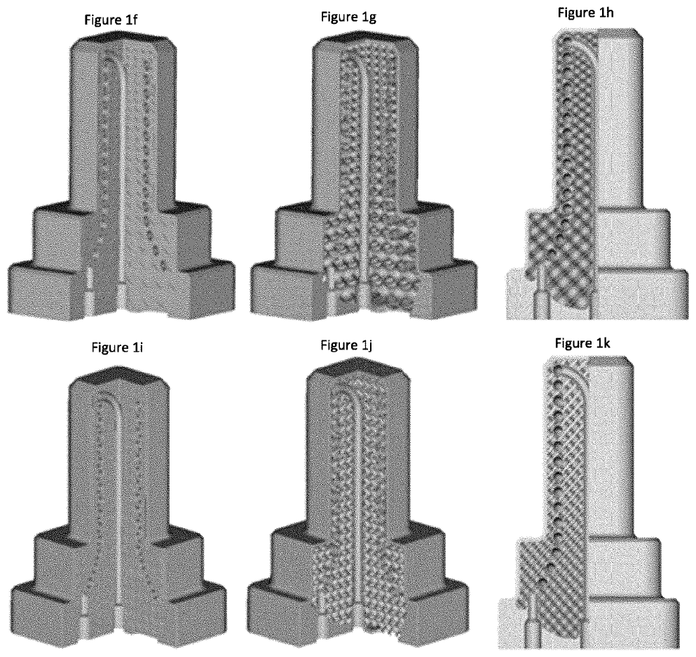

Turning to FIG. 1a, a perspective view of a multi-material component is shown. As shown in FIG. 1, the multi-material component 100 includes a housing or shell portion 102 that provides a shape for the multi-material component 100. FIG. 1b provides a perspective cut-away view of an empty shell portion 102. The shell portion 102 may be seen as having at least one hollow region. FIG. 1c is a perspective cut-away view of the multi-material component 100 including the shell portion 102 and a lattice structure 104 that includes a plurality of hollow, or empty spaces 106 within the lattice structure 104. FIG. 1d is a perspective cut-away view of the component 100 including the shell portion 102, the lattice structure 104 whereby the hollow spaces 106 have been filled with different materials. In one embodiment, the different materials may be a combination of at least one first, or primary, material (which may be seen in one embodiment as gap filler material) and at least one second, or secondary, material (which may be seen as infiltrant material).

Turning to FIG. 1e, an enlarged cut-away view of the multi-material component is shown. Within the shell portion 102 of the component 100, there is a lattice structure 104 with hollow spaces 106 that provides support to the shell portion 102. The lattice structure 104 may also provide a structure for gap filler material 108 and infiltrant material 110 to adhere to during the fabrication of the multi-material component 100. The gap filler material 108 may then be decorated or metallized via the addition of a decoration material on its surface. The decoration material may be seen as being part of the at least one secondary material. An enlarged view of gap filler material 108 including a decoration layer 109 is shown in FIG. 11. The decoration or decoration layer improves the contact or adhesion between the gap filler material 108 and other materials, such as, but not limited to, the infiltrant material 110. In one embodiment, the combination of the gap filler material 108 and the infiltrant material 110 work together to enhance different properties of the multi-material component 100. Selection of the gap filler material 108 and the infiltrant material 110 may be based on desired characteristics of the multi-material component 100. The characteristics may include, but are not limited to, strength, water-resistant properties and/or corrosion-resistant or thermal properties. This will be described in more detail below.

In other embodiments, the internal structure is a lattice structure, such as schematically shown in FIGS. 1f to 1h, to control thermal flow in a predetermined direction using a TPMS lattice structure that is graded by cell size. Turning to FIGS. 1i to 1k, perspective views of a multi-material component where the internal structure is a lattice structure to control thermal flow in predetermined direction using a TPMS lattice structure that is graded by wall thickness.

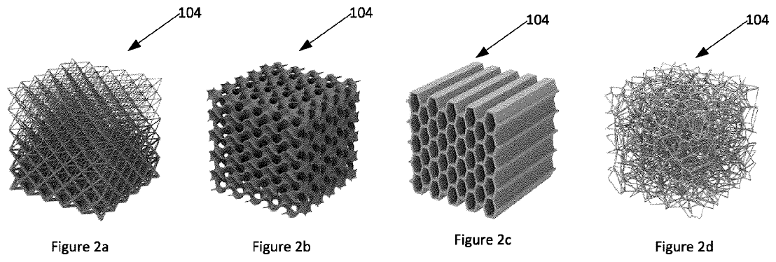

Turning to FIGS. 2a to 2d, examples of different lattice structures are provided. FIG. 2a is a strut-based lattice structure, FIG. 2b is a surface-based lattice structure, FIG. 2c is a honeycomb-shaped lattice structure and FIG. 2d is a stochastic lattice structure.

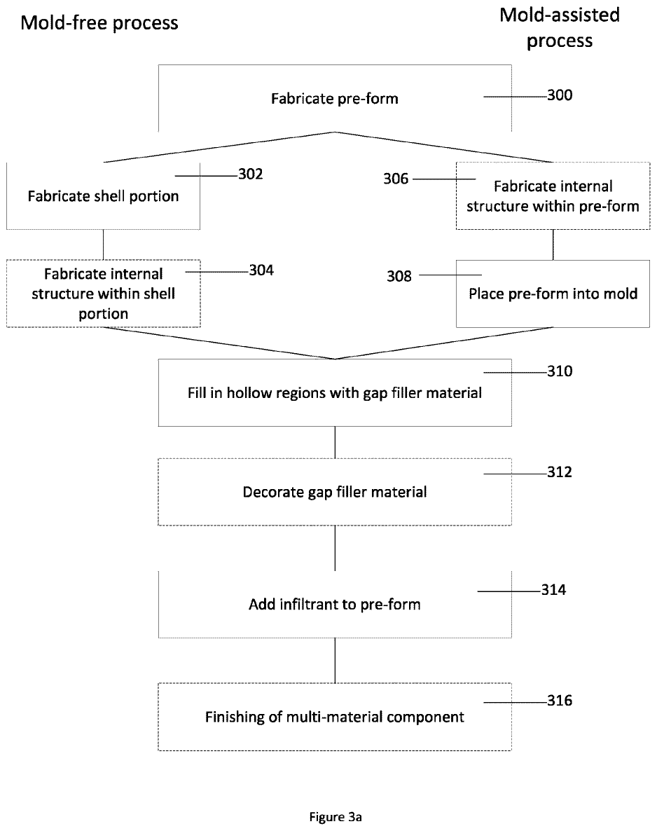

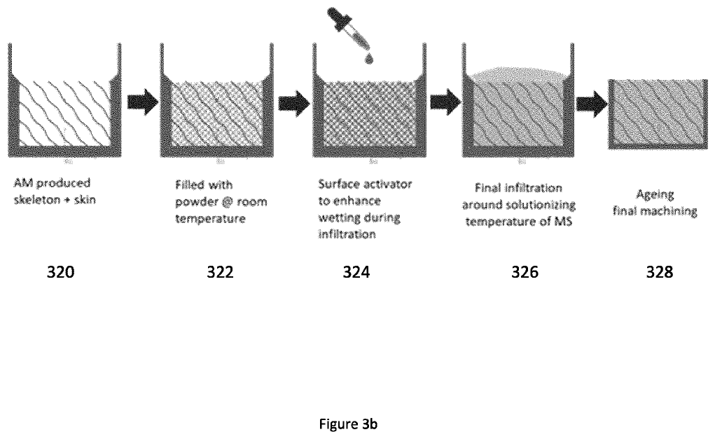

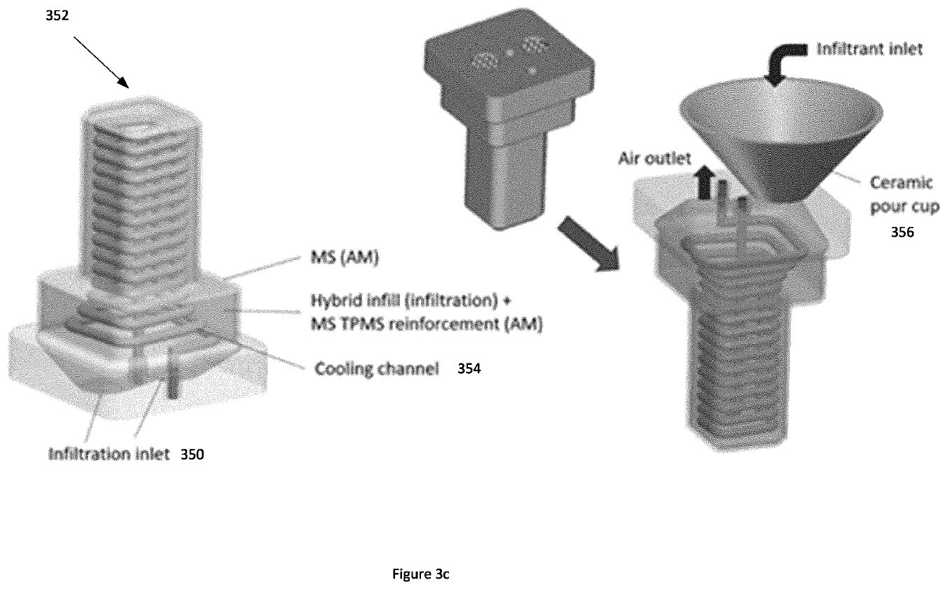

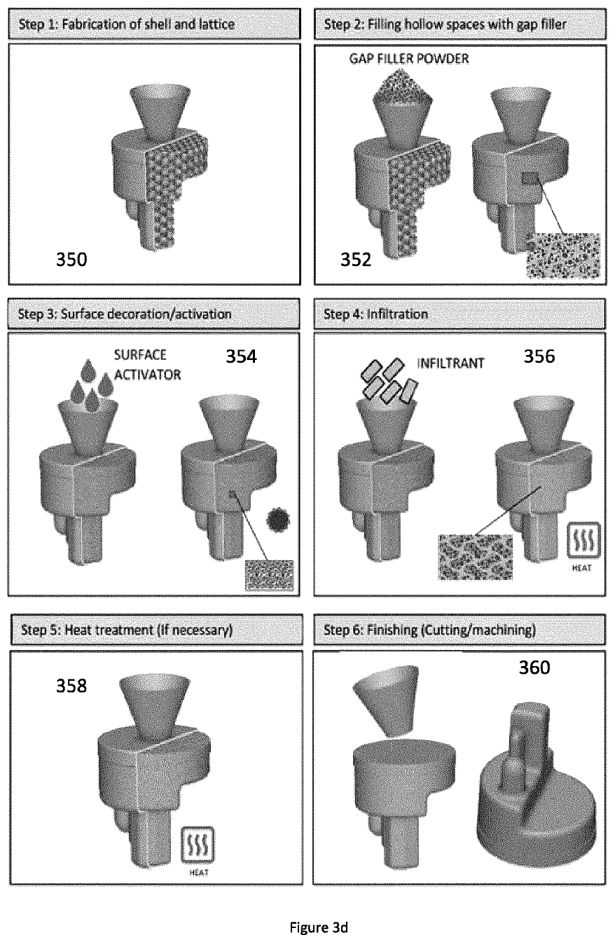

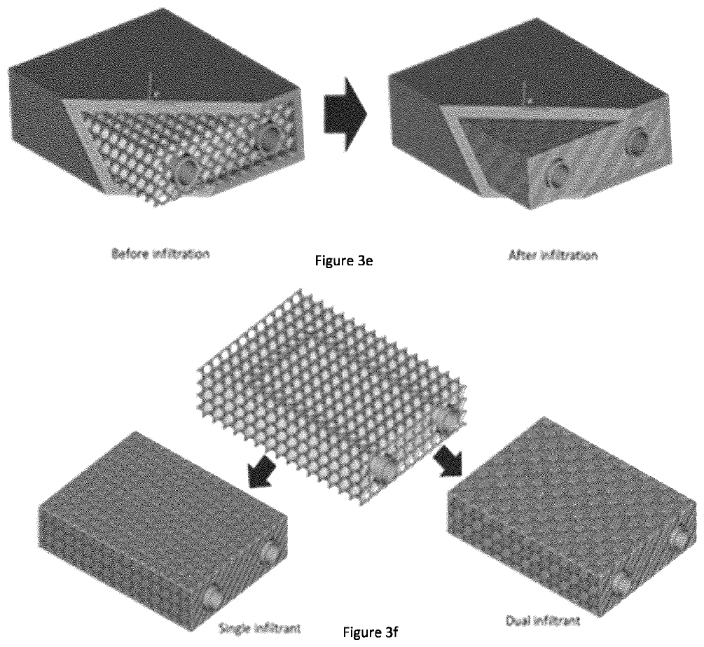

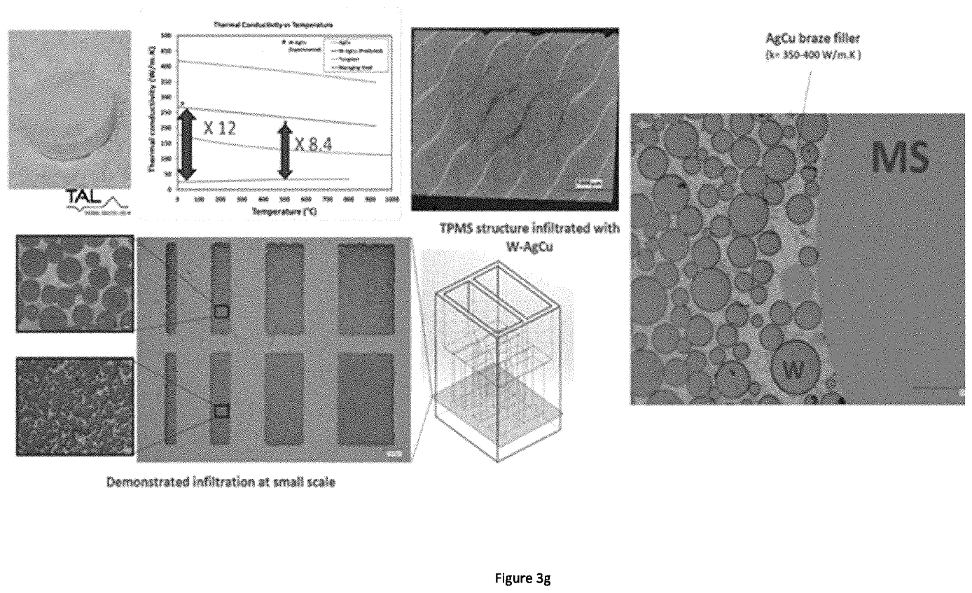

Turning to FIG. 3a, a flowchart outlining a method of fabricating a multi-material component is shown. In some embodiments, the multi-material component may be combined with other multi-material components to form a final product. The flowchart of FIG. 3a shows fabrication methods using a mold-free process and a mold-assisted process.

Prior to the fabrication process, there may be other tasks that are performed which may or may not form part of the method and system of the disclosure. These tasks may assist to provide a multi-material component that has advantages over current components.

Firstly, a design of the material layout of the finished multi-material component may be created before the fabrication process is performed to enable customization of internal and/or external regions of the finished multi-material component, allowing the configuration and layout to be tailored to achieve specific properties or responses within or on the surface of the finished multi-material component. In one embodiment, the design may focus on improving mechanical performance and/or defect tolerance. As the finished multi-material component is made up of multiple materials that are processed at different temperatures, stresses may accumulate at the interfaces between different materials during cooling. By designing the layout or configuration, internal residual stresses can be tailored to reduce or prevent crack propagation in the finished multi-material component by controlling properties, or domains, of the multiple materials that are used. This may be accomplished by generating useful residual stresses within each material domain whereby the multi-material component can be designed or fabricated in response to a stress field using non-uniform design or site-specific layout of every material within the component.

In another embodiment, the design may focus on improving thermal performance. The multi-material component may be designed based on a desired thermal performance whereby, by grading every material domain, an anisotropic or site-specific thermal response, such as, but not limited to, directional heat transfer, may be achieved. This may be beneficial for heat sink applications or tooling. In a further embodiment, the design may focus on designing internal circuitry or sensors. By using material engineering, sensors or other desired three-dimensional (3D) circuitry may be integrated into the finished multi-material component. Examples include, but are not limited to, identification (ID) tags, embedded heating and temperature or stress sensors. In another embodiment, the design may focus on magnetic properties whereby the different material or materials of the multi-material component may be manipulated to provide desired magnetic properties.

Depending on the method of fabrication of the multi-material component, a pre-form is fabricated (300). As discussed above, the multi-material component may be fabricated using a mold-free process or a mold-assisted process. A mold-free process is one where the pre-form includes an outer surface or shell that is able to hold the materials that are inserted or injected during the fabrication process while a mold-assisted process is one where a mold or die is required to assist in the fabrication process where the mold holds the materials that are inserted or injected during the fabrication process.

The pre-form may be seen as a housing (made from similar or different materials) that is not fully processed and requires additional processing to form the finished multi-material component. The pre-form may provide the housing for a finished multi-material product or may provide the housing for a multi-material component that is part of a larger item or product. The pre-form includes at least one hollow space or region which may be seen a void/voids or empty area(s) within the pre-form.

In one embodiment, for use in a mold-free process, a shell or shell portion is fabricated (302) as part of the pre-form. In some embodiments, an internal structure may be fabricated within the shell portion (304). This is shown in dotted lines in FIG. 3a as the shell, or outer, layer, may or may not include an internal structure. Examples of an internal structure include, but are not limited to, a lattice structure. In some embodiments, the shell may be hollow. In the mold-free process, the shell portion acts as a mold for the fabrication process, such as for receiving or housing material inserted during subsequent filling process or processes.

In some embodiments, the shell portion can be of uniform thickness or can be of varying thicknesses depending on mechanical and thermophysical requirements for the finished multi-material component. The shell portion may also be perforated to provide space for a subsequent filling process such as an infiltration process, which allows the infiltrant to end up on or near the surface of the finished multi-material component.

With respect to an inner surface of the shell, the internal surface of the shell can be designed and/or constructed to enhance surface interaction with materials that are added during the fabrication process. In one embodiment, this may be achieved by designing pre-determined features on an internal surface of the shell. In another embodiment, this may be achieved by altering the manufacturing process parameters to create a rougher or smoother inner shell surface. In AM, surface roughness can be manipulated by changing process parameters such as, but not limited to, shell scanning power or speed.

With respect to an outer surface of the shell, the outer surface may be thickened to allow precise post-machining of the pre-form to desired dimensions and tolerances. In other embodiments, the shell may be fabricated from multiple materials that may be welded or brazed separately. The shell may also include a dense and/or porous region to enhance subsequent material attachment such as when the component is part of a larger item. The porous region can include stochastic (random) porosity or designed porosity. Fabrication processes that may be used to fabricate the shell include, but are not limited to, machining, forming and casting or advanced techniques such as additive manufacturing.

As discussed above, the pre-form includes at least one hollow region whereby the pre-form may be completely hollow or may include at least one internal structure that can be subsequently filled with other materials.

In some embodiments, the solid-to-fill ratio within the pre-form may be between 0 to 99%. In other embodiments, the at least one hollow region is occupied with at least one internal structure made with similar or different materials in order to strengthen the finished multi-material component, to improve thermal response of the finished multi-material component and/or to add new functions to the finished multi-material component.

In embodiments where there is an internal structure, such as a lattice structure, the lattice structure may include different cells (which represent the open areas within the lattice structure). The lattice structure may have uniform cell features or may have non-uniform site-specific cell design. Cell attributes such as, but not limited to, size, wall thickness and type can be gradually or abruptly varied in 3D space. Properties of the lattice structure may be correlated to a desired stress field or temperature distribution in the finished multi-material component. The spaces created by the lattice structure can divide the hollow space of the pre-form or shell into interconnected regions or several isolated regions for subsequent filling, such as infiltration, processes. The lattice structure may also include cooling channels.

Examples of internal lattice structures that may be used include, but are not limited to, triply periodic minimal surfaces, gyroids, simple lattice or honeycomb shaped structures. Further examples of internal structures are shown in FIGS. 2a to 2d as discussed above. In some embodiments, the gaps within the structures are designed based on the fabrication process. If the lattice structure divides the at least one hollow region into multiple isolated regions for multi-material filling, each region may have its own dedicated filling channel.

The fabrication of the lattice structure may be performed via AM whereby the lattice structure and the shell may be fabricated in a single step or process. The lattice structure may also be fabricated in a separate process (using additive or non-additive methods) with a material that is the same, similar or different from the material used to fabricate the shell. The lattice structure can be inserted into the pre-form manually by press fitting, shrink fitting or via other known processes.

For a mold-assisted process, if needed, internal structures are fabricated into the pre-form (306) which are then placed within a mold (308). The at least one internal structure assists in holding the materials that are inserted via the subsequent filling processes. In some embodiments, multiple pre-forms may be placed within a single mold and then joined together after the multi-material component fabrication processes have been completed. In some embodiments, the mold may fully or partially cover the pre-form.

The mold can be made of, but is not limited to, a ceramic (such as, but not limited to, phosphate bonded investment or sand) which are typically single use or metal (such as, but not limited to, copper or steel) which may be re-used. Selection of the mold material may depend on the characteristics of the materials that are used for the fabrication process. One characteristic may be the processing temperature for the other materials.

With respect to mold fabrication, a selection of the fabrication method for the mold is dependent on the geometry of the multi-material component and mold material. Metallic molds can be made by conventional methods or additive manufacturing before the pre-form is placed in the mold. In other embodiments, ceramic molds can be cast around the pre-forms or similar geometry like a wax pattern that has an outer shape of the pre-form. This may also be seen as a pre-form being placed within a mold.

In some embodiments, a surface of the mold is sealed to avoid penetration of the ceramic material into it. The sealant can be wax which is melted away with the subsequent process.

For a pre-form that includes a partial hollow region (whereby an internal structure is present), the hollow region may be encompassed by the walls of the multi-material component walls and design within the boundaries of the component. In this case, a gating system may be used for subsequent delivery of infiltrant material (as discussed below). In another embodiment, the hollow region may end up near the surface of the mold and require a molding (ceramic or metal) around it for subsequent filling process.

In other embodiments, the hollow region may be added to an existing component and joined to the main component through a subsequent filling step. In this embodiment, the main component and the add-on hollow region (with lattice or other sub components) can be placed together in a mold cavity as described above. This methodology can be applied to add new function (such as, but not limited to, wear resistance, thermal conductivity or sensory features) to the surface of existing components.

After the set of pre-forms (either via the mold-free or mold-assisted processes) have been fabricated (with or without the internal structures), the at least one hollow region or a portion of the at least one hollow region within the pre-form is filled (310). In some embodiments, the hollow space or regions are filed with one or more powders (which may also be referred to as at least one gap filler or gap filler material). In this process, the at least one hollow region (which may be located within the pre-form and/or on a surface of the pre-form) is filled with the one or more gap filling materials.

In some embodiments, the gap filler or gap filler material is selected based on desired properties of the finished multi-material component. For example, if a high thermal conductivity is required, the gap filler material may be selected from tungsten or molybdenum. If the finished multi-material component requires magnetic characteristics, the gap filler material may be or may include iron and/or nickel. If the finished multi-material component is required to withstand high temperature, the gap filler material may include a temperature-tolerant alloy or ceramic powder component.

In other embodiments, a composite gap filler material that includes at least two powder materials can be used. Also, different hollow regions may be filled with different gap filler materials based on a design and/or expected function of the finished multi-material component at those locations. Each hollow region can also be only partially filled with the gap filler material.

In one embodiment, the gap filler material is added to the hollow regions in powder form whereby the powder can be poured into the hollow region via a funnel. The funnel can be used as an inlet or path from outside of the pre-form to the hollow region or regions for the gap filler material to be added, inserted or injected. If the gap filler material has a high flowability and the internal channels (e.g. lattice structure) are not very narrow, the gap filler material may freely flow into the space. If the gap filler material has a lower flowability, mechanical assistance, such as, but not limited to, mechanical vibration may be used. The gap filler material may also be inserted with the assistance of a liquid medium (such as, but not limited to, water or alcohol) to reduce friction among particles during the filling process and to provide better packing.

If multiple gap filler materials are used for different hollow regions, the lattice structure may be designed to provide multiple non-interconnected spaces or gaps to avoid mixing of the different gap filling materials. In this embodiment, each hollow region or cell may have a dedicated channel or gating that is connected to a surface of the shell or mold where an inlet may be present. For ease of filling, a funnel can be used or designed at each inlet whereby the funnel may also be used for other filling processes.

After the gap filler material has been added, the method may include a decoration of the gap filler material (312). Decoration of the gap filler material may provide improved adhesion or contact between the gap filler material and other materials that are subsequently added to the multi-material component.

In some embodiments, internal surfaces of the shell, pre-form or mold may also be decorated. In some embodiments, if the gap filler material and the base metal (or shell) (including lattice or internal surface of the hollow space) have sufficient wetting with a chosen infiltrant (that is added as one of the subsequent filling processes as discussed below), decoration of the gap filler material may not be required. Otherwise, the surface of the gap filler material and/or internal regions are decorated or metallized, such as with an interlayer of metal which helps to reduce a wetting angle. Decoration can be done via nanoparticle inks such as, but not limited to, silver or gold nanoparticles or a sol-gel driven coating that reduces metals on the surface of the gap filler material and/or decomposition of a salt solution that reduces to a metal. Electroless plating may be applied as well.

Different materials can be used for decorating gap filler materials such as, but not limited to, silver or gold nano-particles in the form of inks, sol-gel precursors or salt solutions in which the compound is decomposed to desired metal upon heating. These may be in solid or liquid forms.

In one embodiment, the decoration of the gap filler material may be via a decorating solution. The decorating solution may include a precursor or nanoparticles dispersed in a carrier that is infused into the shell, pre-form or mold. Application of the decoration solution may be via gravity infiltration, vacuum infusion or pressure-assisted infusion at different predetermined temperatures.

After at least some of the gaps are filled with the decorating solution, as part of the gap filler material decoration, a higher temperature may be applied for sol-gel reactions, evaporation of solvents or decomposition reactions. The heating may also be performed when heating is applied to infuse a molten metal into the remaining hollow regions within the pre-form (as discussed with respect to infiltration below). In some embodiments, decoration of the gap filler material (including heating) may be repeated multiple times to create or fabricate a desired layer thickness or coverage on the internal surfaces. Decoration of the gap filler material may be performed before it is inserted into the pre-form or can be carried out after filling of the space or, in other words, it may be performed before (310) or after (310).

Infiltrant is then added to the multi-material component (312) via an infiltration process. The infiltration process may include adding one or more molten metals to fill in the remaining hollow regions or gaps within the pre-form to fabricate a solid, or finished, multi-material component. This may be done at different temperatures, but is typically performed at a temperature above the melting point of the infiltrant.

Selection of the infiltrant material may be based on a desired property or characteristic for the finished multi-material component. In some embodiments, the infiltrant material may be selected based on a desired property or characteristic of the, pre-form, shell, mold, or tool. The selected infiltrant material should be compatible with the gap filler material and decoration layer in terms of wetting, elemental exchange and bonding behaviour.

In some embodiments, the infiltrant material or base metal may interact with the decorated gap filler material by elemental exchange. In other words, the decorated gap filler material or the decorating material/solution may or may not change the elemental composition of the base alloy or the infiltrant but may have some positive effects on improving the performance of both the infiltrant and the alloy by forming secondary phases or reactants. The decorating material can be designed in a way to minimize or reduce chemically isolated gap filler material particles from the infiltrant and reduce or prevent unnecessary reactions.

One specific example is the use of an aqueous solution of silver nitrate which fully decomposes into silver particles upon heating above 440° C. In this example, the decoration process finishes at a temperature below the infiltration temperature such that when the infiltration process (314) is performed, the decoration process (312) is also completed. In another approach, the surface of the gap filler materials can be oxidized, carburized, nitridized or borized to form a protective or reactive layer on the surface of the gap filler material. This can be done through an evaporation/condensation process, physical vapor deposition, chemical vapor deposition, sol gel, an acid treatment or a basic treatment before or after to filling of gap filler material in the hollow space. A similar process can be applied on the surface of the pre-form as well.

In one embodiment, the gap filler material has a higher melting point than the infiltrant so that it does not melt during the addition of infiltrant to the pre-form (314). The gap filler material can be also reactive or non-reactive with the selected infiltrant material.

In other embodiments, the melting point of the infiltrant can be lower than the melting point of the base metal (metal used for the shell) and gap filler material whereby infiltration may induce partial melting of the gap filler material. If the gap filler material is very active in liquid phase sintering, the infiltration time may be reduced to avoid or reduce excessive shrinkage. In some embodiments, reactive infiltration may be used to improve the wetting characteristics whereby the infiltrant material reacts with the gap filler material and the thermal shrinkage due to reaction is calculated to avoid stresses in the final multi-material component or final larger item. The thermal cycle for infiltration should not excessively interfere with the heat treatment cycle of the base alloy.

In one embodiment, the addition of infiltrant to the pre-form may be performed via the introduction of molten metal into the remaining gaps within the pre-form. The molten metal may be delivered, or inserted, into the component via an inlet or funnel that is located on the side or top of the pre-form and channelled to a molten metal reservoir which can freely let the material flow to fill in the remaining space within the shell and/or mold. In some embodiments, this process can be done under atmospheric pressure if there is an improved wetting of the two materials. In other embodiments, the infiltration process may be performed in or under a vacuum condition. In yet another embodiment, the infiltrant can be squeezed into the remaining spaces by applying a gas pressure or a hydraulic plunger, similar to those used in a die casting process. Vacuum can also be used to remove air from the pre-form to reduce or prevent back pressure built up during the infiltration process. If multiple infiltrants are used to fill in the gaps, the inlet for each region has to be separated as well in the design stage. The melting process can be performed using resistance heating furnaces, induction heating, flame heating or plasma heating. In case of multiple infiltrant it might be done under one thermal cycle or multiple cycles.

Table 1 provides some examples of different combination of gap filler materials, decorating materials and infiltrant materials that may be used to fabricate a multi material component.

| Gap filler | Decorating layer | Infiltrant |
|---|---|---|
| Tungsten | Silver nanoparticles | Silver-Copper alloy (CuAgNi) |
| | Gold nanoparticles | Ag—(20-30 wt %)Cu—(0.1-2 wt % Ni) |
| | | Silver alloy |
| | | Copper alloy (ex. CuCrZr) |
| Molybdenum | Silver nanoparticles | Silver-Copper alloy (CuAgNi) |
| | Gold nanoparticles | Ag—(20-30 wt %)Cu—(0.1-2 wt % Ni) |
| | | Silver alloy |
| | | Copper alloy (e.g. CuCrZr) |
| Tungsten | Silver nanoparticles | Silver-Copper alloy (CuAgNi) |
| carbide | | Ag—(20-30 wt %)Cu—(0.1-2 wt % Ni) |
| | | Silver alloy |
| | | Copper alloy |
| | | Cobalt alloy |
| | | (Palladium, indium, tin, nickel and titanium |
| | | may exist in the infiltrant in amounts ranging |
| | | from 0% to 15%) |
| High strength | Gold nanoparticles | Bronze |
| steel | Silver nanoparticles | Silver-Copper alloy (CuAgNi) |
| | Nickel coating | Ag—(20-30 wt %)Cu—(0.1-2 wt % Ni) |
| | | Silver alloy |
| | | Copper alloy |
| | | NiAl |
| | | FeAl |
| | | (Palladium, indium, tin, nickel and titanium |
| | | may exist in the infiltrant in amounts ranging |
| | | from 0% to 15%) |
| Silicon carbide | Gold nanoparticles | Silicon |
| | Nickel coating | Aluminium |
| Tantalum | Silver nanoparticles | Gold |
| Carbide | Nickel coating | Aluminium |
| | | Copper |
| Titanium carbide | Nickel or silver coating | Copper alloy |
| Graphite | | Silicon |
| Diamond | Nickel coating | Silver-Copper alloy (CuAgNi) |
| | metallization based on | Ag—(20-30 wt %)Cu—(0.1-2 wt % Ni) |
| | carbide-forming metals, | Silver alloy |
| | which provides a strong | Copper alloy |
| | chemical bonding with | (Palladium, indium, tin, nickel and titanium |
| | the diamond surface | may exist in the infiltrant in amounts ranging |
| | (Cr, Ti, W, Mo, and | from 0% to 15%) |
| | others) | |
| Boron carbide | Gold nanoparticles | Silver-Copper alloy (CuAgNi) |
| | Silver nanoparticles | Ag—(20-30 wt %)Cu—(0.1-2 wt % Ni) |
| | Nickel coating | Silver alloy |
| | | Copper alloy |
| | | (Palladium, indium, tin, nickel and titanium |
| | | may exist in the infiltrant in amounts ranging |
| | | from 0% to 15%) |
| Boron nitride | Gold nanoparticles | Silver-Copper alloy (CuAgNi) |
| | Silver nanoparticles | Ag—(20-30 wt %)Cu—(0.1-2 wt % Ni) |
| | Nickel coating | Silver alloy |
| | | Copper alloy |
| | | (Palladium, indium, tin and titanium may exist |
| | | in the infiltrant in amounts ranging from 0% to |
| | | 15%) |
| Aluminum | Gold nanoparticles | Silver-Copper alloy (CuAgNi) |
| Nitride | Silver nanoparticles | Ag—(20-30 wt %)Cu—(0.1-2 wt % Ni) |
| | Nickel coating | Silver alloy |
| | | Copper alloy |
| | | (Palladium, indium, tin, nickel and titanium |
| | | may exist in the infiltrant in amounts ranging |
| | | from 0% to 15%) |
| Silicon Nitride | Gold nanoparticles | Silver-Copper alloy (CuAgNi) |
| | Silver nanoparticles | Ag—(20-30 wt %)Cu—(0.1-2 wt % Ni) |
| | Nickel coating | Silver alloy |
| | | Copper alloy |
| | | (Palladium, indium, tin, nickel and titanium |
| | | may exist in the infiltrant in amounts ranging |
| | | from 0% to 15%) |
| Aluminum Oxide | Gold nanoparticles | Silver-Copper alloy (CuAgNi) |
| | Silver nanoparticles | Ag—(20-30 wt %)Cu—(0.1-2 wt % Ni) |
| | | Silver alloy |
| | Nickel coating | Copper alloy |
| | Chromium coating | (Palladium, indium, tin, nickel and titanium |
| | | may exist in the infiltrant in amounts ranging |
| | | from 0% to 15%) |

Turning to FIG. 3c, a schematic diagram showing an infiltration process setup in a tool of maraging steel is shown. An infiltration inlet 350 is located on a surface of the pre-form 325 that allows infiltrant to be added to the pre-form. At least one cooling channel 354 may also be located within the pre-form 352. It is understood that in other embodiments, there may not be a need for a cooling channel. A funnel made of metal or ceramic (pour cup) 356 is connected to the infiltration inlet 350 so that the infiltrant can be added. This funnel or cup can be manufactured together with the part or can be made separately.

After the infiltration process, the multi-material component may then be finished (316). Finishing may include one or more different tasks so that the multi-material component maybe seen as being in its final format. Finishing may include, but is not limited to, removal of gating systems from the components; removal of the mold material; removal of the excess material from outer surface of the shell through subsequent machining and reaching desired tolerances; a heat treatment (if needed, although it can be combined with the infiltration cycle as well); and/or final machining/polishing/grinding to desired tolerances. Finishing may include polishing or grinding the shell portion to partially or fully expose the material beneath.

Turning to FIG. 3b, a schematic diagram showing another embodiment of a method of fabricating a multi-material component is shown. The method shown in FIG. 3b may be seen as a method of fabrication of hybrid tooling. Initially, AM is used to fabricate a pre-form or a shell (320). In the current embodiment, AM is used to manufacture a shell with a core of lattice structures (homogenous or graded) and cooling channels. In one embodiment, the lattice structure is a Triply Periodic Minimal surfaces (TPMS) structure due to isotropic mechanical properties and easy manipulation of design. Excess tool steel powder may then be removed from the lattice structure. The hollow regions (or the cells of the lattice structure) are then filled with a refractory material such as Tungsten or Molybdenum as the gap filler material (322). When tungsten is used, a decoration of the surface of tungsten particles is performed (324) using nano or submicron particles (such as silver ink) through room temperature ink infiltration.

Infiltration (326) of the refractory metal with suitable infiltrant such as silver or copper alloys with a compatible wetting angle and melting point with a heat treatment temperature of tool steel is then performed before a heat treatment is applied and final finishing of the tool (328).

Turning to FIG. 3d, another set of drawings showing a further method of fabricating a multi-material component is shown.

Initially, a shell portion and lattice structure are fabricated together (350). Processes that may be used to fabricate the shell portion and lattice structure may be, but are not limited to, machining, AM (laser powder bed fusion, electron beam melting, binder jet printing, metal paste extrusions, etc.), forming, casting, powder metallurgy and the like. At least some of the gaps (or hollow regions) within shell and lattice structure are then filled with at least one gap filler material (352). In one embodiment, the at least one gap filler material is a powder with a predetermined or specific particle size and morphology that allows for a smooth filling of the gaps within the lattice structure. As discussed above, the filling or insertion of the at least one gap filler material may be assisted by vibrations, or a liquid.

The at least one gap filler material is then decorated (354) or activated. Decoration may be used to improve wetting between the at least one gap filler material and other materials that are to be added to the multi-material component. If a ceramic is used as one of the at least one gap filler materials, the metallization of a surface of the ceramic particles may be required. Electroplating, electroless deposition, ink infiltration and/or a sol-gel process may be used for the decorating the at least one gap filler material.

An infiltration process (356) is then performed. In one embodiment, molten metal is poured into the shell portion and lattice structure combination. The molten metal infiltrates the porous material (within the at least one gap filler material) filling all voids and channels. In one embodiment, the infiltration process is driven by capillary action where the molten metal is drawn into the at least one gap filler material due to a pressure differential between the molten metal and the gaps or spaces within the at least one gap filler material. The infiltration process may be enhanced under vacuum or pressure above atmospheric pressure to squeeze the molten metal into the gaps.

A secondary heat treatment (if necessary) (358) is then applied to the component. The secondary heat treatment may be required to produce a desired microstructure within the component. This may be performed by solution annealing, quenching, aging, tempering and the like. This secondary heat treatment may also be combined with the infiltration process (356). The component is then finished (360). Finishing may include, but is not limited to, cutting off the infiltration grating system, machining or grinding to a desired geometry. The finishing may also occur before the secondary heat treatment (if performed).

Turning to FIG. 3e, schematic drawings showing a pre-form before and after undergoing an infiltration process are provided. As can be seen, after the infiltration process, the pre-form or multi-material component can be seen as being filled.

Turning to FIG. 3f, schematic diagrams showing results of a lattice structure after receiving a single infiltrant and after receiving a dual infiltrant are shown.

While the fabrication methods taught above are directed at a multi-material metallic component, it may also be applied to the fabrication of a multi-material polymer/metal composite component. In one example, a metal lattice structure may be printed via AM and placed in a cavity of an injection mold to be over molded with a thermoplastic or thermo set material. The internal metal lattice structure provides benefits to the plastic part such as, but not limited to, strength, sensory functions and/or wear resistance. In another example, a copper circuitry framework can be printed via AM to obtain a polymer matrix for an over injection molding process. Similar tasks may be applied for a metal die casting process whereby there is an internal framework/structure (lattice structure or non-lattice structure) of other metals placed in a mold cavity and die cast the alloy over it to make a composite metal that includes two or multiple metals. Similar process can be applied in investment casting process, where a structure, lattice or hollow component produced by AM or other conventional tools inserted in the mould for wax injection and subsequent casting cycle.

The disclosure may also find benefit in or be applied to high temperature tooling/molding. Advantages include at least one of improving an overall thermal performance of the tool; reducing a thermal gradient; extending a life of the tool; blocking crack propagation within a core of the tool; lowering surface temperature stresses; controlling solidification by spatial manipulation of thermal conductivity over the tool geometry; saving build time and cost in additive manufacturing.

In some embodiments, the disclosure provides an improved method to fabricate a multi-material component or tool with a thermal performance of about five to seven times better than conventional tools. By providing a finished multi-material component that includes a hollow pre-form made of steel with a core of lattice structure such as triply periodic minimal surface (TPMS) and cooling channels. Using a highly conductive gap filler material such as Tungsten that fills the gaps or cells within the lattice structure and a low temperature infiltrant material that activates the surface of gap filler material and provides a compatible contact angle with the gap filler material, infiltrant, and tool steel that can be spontaneously infiltrated. In the case of a TPMS lattice structure, there is a freedom to have cells to be filled with at least two different gap filler materials to provide a mismatch in thermal expansion which may create useful residual stresses within material that can reduce or prevent crack propagation.

Another advantage of the disclosure is that a lifetime of the finished multi-material component or tool is extended as the thermal resistance of the tool or finished multi-material component is greatly reduced which can significantly reduce thermal gradient and surface temperature. In experiments, thermal conductivities in the order of 180 to 200 W/m·K were achieved whereas new high strength tool steels rarely reach 50 W/m·K. The disclosure also allows for the production of a super structure of multiple infiltrants that create useful residual stresses upon cooling that reduces or prevents crack propagation and increase fracture toughness of the material.

Another advantage of the disclosure is that performance is improved as thermal performance of the tool or finished multi-material component is hugely impacted by a core that includes a highly conductive material such as tungsten and silver. Use of tungsten or silver is reinforced by continuous lattice structures that are printed by AM at the core of the tool. In general, this combination enhances the dissipation of the heat and reduces the cycle time. By varying the lattice structure, full spatial control over the thermal performance of the tool at different locations is possible. For instance, in a die casting process, directional solidification on the tool cavity by varying the lattice structure in the core of the tool is also possible.

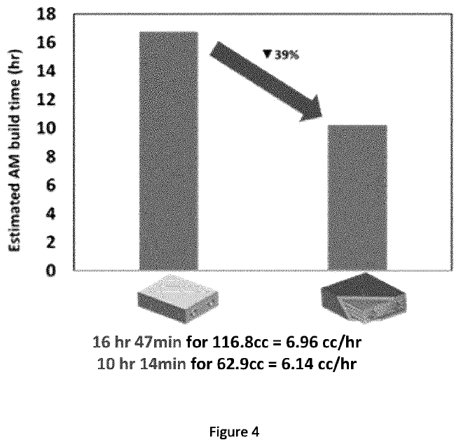

Another advantage of the disclosure is reduced costs as reducing thermal resistance on the tool or multi-material component allows for a shorter cycle time which provides huge manufacturing cost saves in the long run. Since the lattice structure is produced within the tool, a huge cost savings in AM production, in terms of printing time and material cost is realized. The secondary processes of the disclosure are minimal and mostly can be combined with the heat treatment of the tool. FIG. 4 provides a chart showing the time savings.

Therefore, in some embodiments, the disclosure achieves at least one of reduces thermal fatigue; extends the lifetime of a multi-material component, enhances the cycle life and/or reduce manufacturing time.

In some embodiments, the disclosure may be used in the die cast and plastic injection tooling industry. In another embodiment, the disclosure may be targeted at the extrusion and/or forge dies industry.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A method of fabricating a multi-material component made of a base metal comprising:
fabricating a pre-form with at least one hollow region;
adding at least one gap filler material to the pre-form; and
performing an infiltration process to fill a remainder of the at least one hollow region with at least one infiltrant material.

2. The method of claim 1 further comprising:
decorating the at least one gap filler material before or after adding the at least one gap filler material to the pre-form.

3. The method of claim 1 wherein fabricating a pre-form comprises:
fabricating a shell portion for housing the at least one gap filler material and the at least one infiltrant material.

4. The method of claim 3 wherein fabricating a pre-form further comprises:
fabricating an internal structure within the shell portion.

5. The method of claim 4 wherein the internal structure is a lattice structure.

6. The method of claim 5 wherein the lattice structure is a triply periodic minimal surface (TPMS) structure.

7. The method of claim 1 wherein fabricating a pre-form comprises:
fabricating an internal structure; and
inserting the internal structure within a mold.

8. The method of claim 1 further comprising:
finishing the pre-form to fabricate a finished multi-material component.

9. The method of claim 8 further comprising:
integrating the finished multi-material component with other components of a larger finished item.

10. The method of claim 1 further comprising:
performing a heat treatment on the pre-form after performing the infiltration process.

11. A multi-material component comprising:
at least one gap filler material; and
at least one infiltrant material mixed with the at least one gap filler material.

12. The multi-material component of claim 11 further comprising a lattice structure.

13. The multi-material component of claim 12 further comprising a shell portion.

14. The multi-material component of claim 13 where the shell portion is of varying thickness.

15. The multi-material component of claim 11 wherein the at least gap filler material is selected from tungsten, molybdenum, tungsten carbide, high strength steels, silicon carbide, tantalum carbide, titanium carbide, graphite or diamond, boron carbide, boron nitride, silicon nitride aluminum nitride or aluminum oxide.

16. The multi-material component of claim 11 wherein the at least one infiltrant material is selected from a silver copper alloy, a silver alloy, a copper alloy, bronze, nickel aluminide, iron aluminide, silicon, aluminium, a cobalt alloy, palladium, nickel, indium, tin, titanium or gold.

17. The multi-material component of claim 11 further comprising at least one decorating material.

18. The multi-material component of claim 17 wherein the at least one decorating material is selected from silver nanoparticles, gold nanoparticles, chromium, nickel coating or a silver coating.
